(19) United States
(12) Patent Application Publication
(10) Pub. No.: US 2008/0076489 A1
(43) Pub. Date: Mar. 27, 2008

(54) Physically and electrically-separated, data-synchronized data sinks for wireless systems

(75) Inventors: Douglas K. Rosener, Santa Cruz, CA (US); Jay Wilson, Portola Valley, CA (US); Scott Walsh, Foxham (GB); David Huddart, Westbury-on-Trym (GB); Andrew Knowles, Southampton (GB)

Correspondence Address: PLANTRONICS, INC., 345 ENCINAL STREET, P.O. BOX 635, SANTA CRUZ, CA, 95060-0635, US

(73) Assignee: PLANTRONICS, INC.

(21) Appl. No.: 11/500,571

(22) Filed: Aug. 7, 2006

(51) Int. Cl. H04M 1/00

(52) U.S. Cl. 455/575.2

(57) ABSTRACT

Wireless systems having a plurality of physically and electrically-separated data sinks. An exemplary wireless system includes first and second data sinks having no physical or electrical connection therebetween. The first and second data sinks each include a wireless communication device, e.g., a radio frequency (RF) receiver or transceiver configured to receive data signals over one or more single-access wireless links or over a multi-access wireless link. The first and second data sinks in exemplary embodiments may comprise audio data sinks, e.g., stereo speakers, left-ear and right-ear earphones (e.g., earbuds or canalphones), left-ear and right-ear circum-aural over-the-ear headphones, etc. At least one of the first and second data sinks may also be coupled to a wireless transmitter and accompanying data source (e.g., a microphone or sensor), so as to provide, for example, two-way communications between a user and an external data device (e.g., a cellular telephone).

### FIELD OF THE INVENTION

The present invention relates to wireless systems. More particularly, the present invention relates to wireless communication between a data source and two or more and physically and electrically-separated wireless data sinks such as, for example, wireless earphones.

### BACKGROUND OF THE INVENTION

Headphones have come into widespread use ever since they were invented in the late 1930s. Today, headphones are used in numerous industrial settings, for listening to music and radio broadcasts, and for receiving voice communications from mobile telephones. A conventional pair of headphones comprises a pair of sound transducers (i.e., speakers), which are configured to receive electrical signals from an audio source (e.g., compact disk (CD) player, digital audio player (MP3 player), cellular telephone, personal digital assistant (PDA), or personal computer) and provide sound to a user's ears.

FIGS. 1A and 1B are illustrations of a user 100 wearing two different types of early-model headsets The headset in FIG. 1A comprises a pair of headphones 102, 104, a headband 106 and a pair of electrical cables 108, 110, which connect the headphones 102, 104 to an external audio source. The headband 106 is worn over the top of the user's 100 head, and physically connects the pair of headphones 102, 104. A cable clip 112 may be used to secure the electrical cables 108, 110 so that they do not interfere with the movement of the user 100 and to prevent tangling of the electrical cables 108, 110. The headset in FIG. 1B is similar to the headset in FIG. 1A, except that only a single electrical cable 114 is connected between one of the headphones 102, 104 and the audio source. Because cabling is provided only to a single headphone 102, electrical wiring is routed through the headband 106 to electrically connect the headphones 102, 104. The headsets in FIGS. 1A and 1B are often referred to in the art as “binaural” headsets since they each comprise a headset having a pair of headphones 102, 104 for each of the user's 100 ears.

Recent advances in wireless technology have allowed the design and manufacture of wireless headsets. For example, the recent introduction of the Bluetooth industrial specification (also known as the IEEE 802.15.1 standard) allows a user to establish a short range wireless personal area network (PAN) in which various electronic devices (e.g., cell phones, PDA's, MP3 players, personal computers, printers, etc.) can communicate with each other over wireless links. Because the PAN is a radio communication system using low gain antennas, the Bluetooth enabled devices do not have to be in line of sight of each other. Furthermore, because the PAN is completely wireless, the clutter and obstruction of electrical cables can be avoided.

FIG. 2 is an illustration of a user 200 wearing a binaural Bluetooth enabled headset. Similar to the wired headsets in FIGS. 1A and 1B, the Bluetooth enabled headset in FIG. 2 comprises a pair of headphones 202, 204 and a headband 206, which physically connects the pair of headphones and provides support for positioning the headset over the user's 200 head. Electrical wiring within the headband 206 electrically connects the pair of headphones 202, 204. Rather than using electrical cabling between the headphones 202, 204 and the external audio source, as is done in the conventional wired headsets in FIGS. 1A and 1B, one of the headphones 202, 204 of the Bluetooth enabled headset includes a Bluetooth transceiver that wirelessly communicates with a Bluetooth enabled external audio source 208 over a wireless link 210.

The binaural wireless headset in FIG. 2 does afford the benefits of wireless operation. However, similar to the traditional wired headsets shown in FIGS. 1A and 1B, the headphones 202, 204 are physically connected by a headband 206. Some users find wearing a headband to be uncomfortable and/or disruptive to their headdress or coiffure.

One way to avoid the drawbacks associated with use of a headband is to use a pair of conventional wired earbuds. An earbud is a small headphone that fits into the concha of the pinna of the user's ear. FIG. 3 shows a user 300 wearing a pair of wired earbuds 302, 304. A pair of electrical cables 306, 308 connects transducers within the earbuds 302, 304 to an external audio source. A cable clip 310 may also be used to secure the electrical cables 306, 308 so that they do not interfere with the movement of the user 300 and to prevent tangling of the electrical cables 308, 310. While use of earbuds does avoid the drawbacks of having to wear a headband, their use still requires cabling (i.e. wires) between the earbuds and the external audio device.

Another type of headset that avoids the use of a headband is the Bluetooth enabled over-the-ear wireless headset. This type of headset is known in the art as a “monaural” headset, since it operates with only one of the user's two ears. FIG. 4 is an illustration of a user 400 wearing a Bluetooth enabled over-the-ear wireless headset. The headset includes a headphone 402 and an earloop 404 that is configured to fit around the outer ear of the user 400. The headphone 402 includes a single audio transceiver for placement near the ear and a voice tube 406 for directing sound from the user's voice to a microphone within the headphone housing. The single audio transceiver communicates with an external wireless audio device 408 (e.g., a cellular telephone) over a wireless link 410.

Because the Bluetooth enabled over-the-ear wireless headset is monaural, it is incapable of providing high-fidelity stereo audio to the user 400. For this reason, such devices are used primarily for enabling hands-free operation of a mobile telephone and not for listening to music.

Each of the various types of prior art headsets described above has its own unique benefits and drawbacks. For example, a benefit of the conventional wired binaural headsets in FIGS. 1A and 1B are that they are relatively inexpensive to manufacture and acquire. A benefit of the binaural Bluetooth enabled headset in FIG. 2 is that it is wireless and provides stereo audio. Unfortunately, each of these three types of headsets requires the use of a headband and/or an electrical connection (i.e., electrical wiring) between the two headphones of the headset. The earbud type headset is beneficial in that it obviates the need for a headband. However, the earbuds are also wired, i.e., require cabling to electrically connect the transducers in the earbuds to an external audio device. Finally, whereas the Bluetooth enabled over-the-ear wireless headset avoids both the need for a headband and the need for cabling to connect to an external audio device, it is, unfortunately, monaural. Consequently, it is incapable of providing high-quality stereo sound to a user.

### BRIEF SUMMARY OF THE INVENTION

Wireless systems having a plurality of physically and electrically-separated data sinks are disclosed. An exemplary wireless system includes first and second data sinks having no physical or electrical connection therebetween. The first and second data sinks each include a wireless communication device, e.g., a radio frequency (RF) receiver or transceiver configured to receive data signals over one or more single-access wireless links or over a multi-access wireless link. The first and second data sinks in exemplary embodiments described herein comprise audio data sinks, e.g., left-ear and right-ear earphones (e.g., earbuds or canalphones), left-ear and right-ear circum-aural over-the-ear headphones, stereo speakers, speakers for a surround sound system, etc. At least one of the first and second data sinks may also be coupled to a wireless transmitter and accompanying data source (e.g., a microphone or sensor), so as to provide, for example, two-way communications between a user and an external data device (e.g., a cellular telephone). Those of ordinary skill in the art will readily appreciate and understand that the inventions defined by the claims attached hereto are not be limited to or by the summary of the exemplary embodiments provided here or to or by the detailed description of the exemplary embodiment set forth below.

Further features and advantages of the present invention, as well as the structure and operation of the various exemplary embodiments of the present invention, are described in detail below with respect to accompanying drawings, in which like reference numbers are used to indicate identical or functionally similar elements.

### BRIEF DESCRIPTION OF THE DRAWINGS

FIG. 1A is an illustration of a user wearing a prior art headset comprising a pair of headphones connected by a headband, where both headphones are connected to a pair of cables leading to an external audio source;

FIG. 1B is an illustration of a user wearing a prior art headset comprising a pair of headphones connected by a headband, where only one of the pair of headphones is connected to a cable leading to an external audio source, and where the headphones are electrically coupled by wiring within the headband of the headset;

FIG. 2 is an illustration of a user wearing a prior art binaural Bluetooth enabled headset having a headband that physically connects the two headphones of the headset;

FIG. 3 is an illustration of a user wearing a pair of prior art wired earbuds;

FIG. 4 is an illustration of a user wearing a prior art Bluetooth enabled over-the-ear monaural wireless headset;

FIG. 5 is an illustration of a user wearing a wireless headset comprising first and second wireless earphone, in accordance with an embodiment of the present invention;

FIG. 6 is a diagram showing a wireless system that may be used to wirelessly transmit data signals to two or more data sinks, in accordance with an embodiment of the present invention;

FIG. 7A is a diagram of a two-stage transmitter that may be used to implement each of the first and second transmitters in the wireless system shown in FIG. 6, in accordance with embodiments of the present invention;

FIG. 7B is a diagram of a direct conversion transmitter that may be used to implement each of the first and second transmitters in the wireless system shown in FIG. 6, in accordance with embodiments of the present invention;

FIG. 8A is a diagram of a superheterodyne receiver that may be used to implement each of the first and second receivers in the wireless system shown in FIG. 6, in accordance with embodiments of the present invention;

FIG. 8B is a diagram of a direct conversion receiver that may be used to implement each of the first and second receivers in the wireless system shown in FIG. 6, in accordance with embodiments of the present invention;

FIG. 9 is a diagram of an RF transceiver that may be used in place of one or more of the RF transmitters and receivers of the various disclosed embodiments, in accordance with embodiments of the present invention;

FIG. 10 is a diagram showing a wireless system that may be used to wirelessly transmit data signals to two or more data sinks, in accordance with an embodiment of the present invention;

FIG. 11 is a diagram showing a wireless system that may be used to wirelessly transmit data signals to two or more data sinks, in accordance with an embodiment of the present invention;

FIG. 12 is a diagram showing a wireless system that may be used to wirelessly transmit data signals to two or more data sinks, in accordance with an embodiment of the present invention;

FIG. 13 is a diagram showing a wireless system that may be used to wirelessly transmit data signals to two or more data sinks, in accordance with an embodiment of the present invention; and

FIG. 14 is a diagram showing a wireless system that may be used to wirelessly transmit data signals to two or more data sinks, in accordance with an embodiment of the present invention.

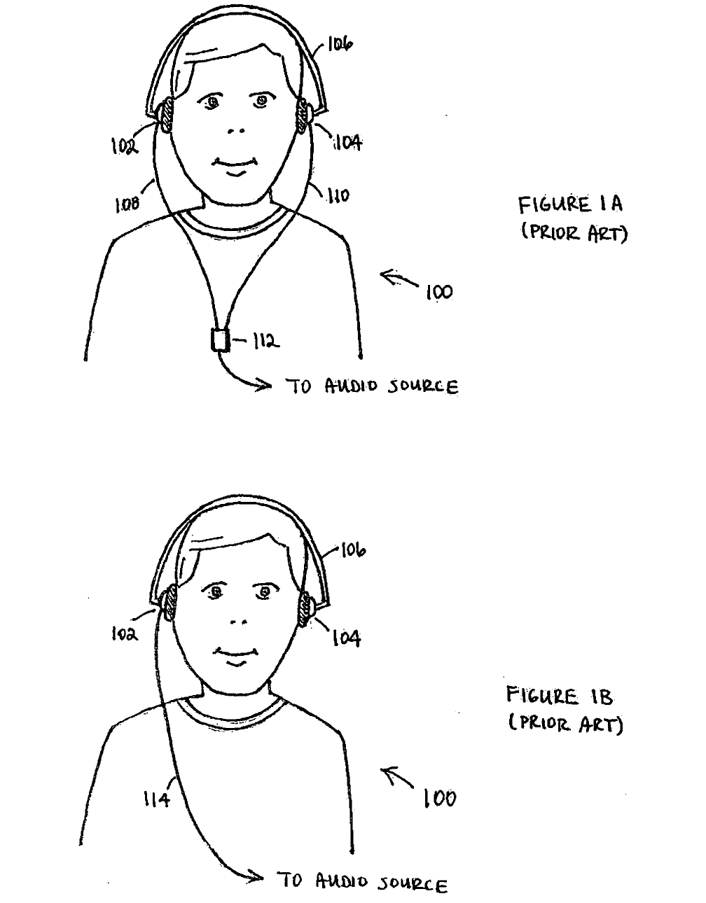

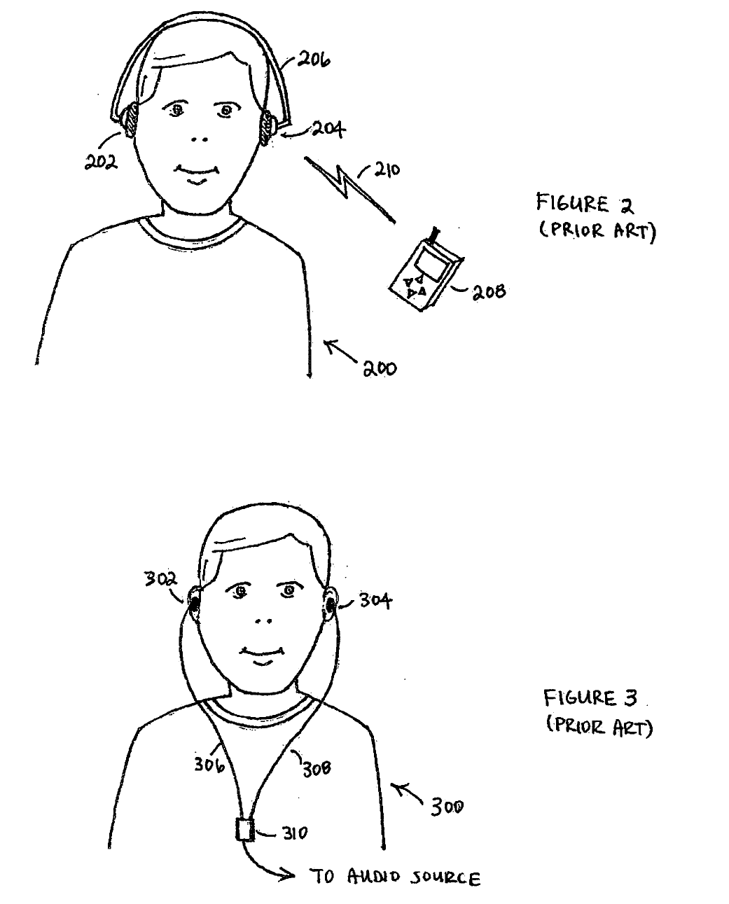

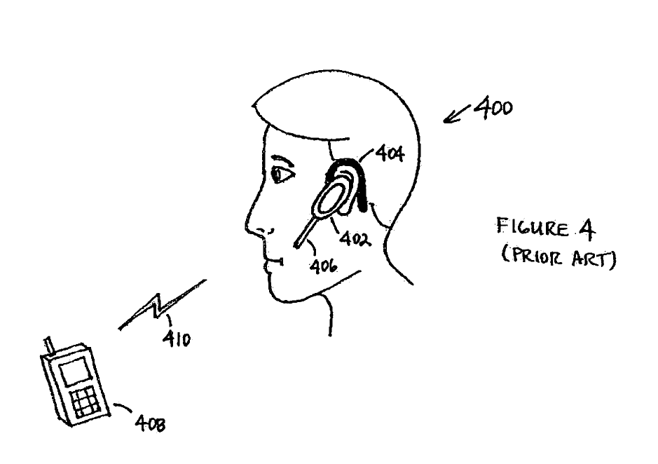

### DETAILED DESCRIPTION

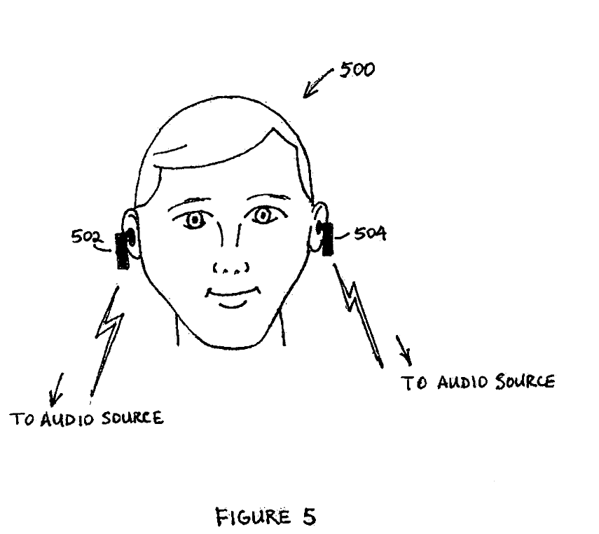

FIG. 5 is an illustration of a user 500 wearing a wireless headset comprising first and second wireless earphones 502, 504, in accordance with an embodiment of the present invention. Each of the first and second wireless earphones 502, 504 comprises a housing containing a speaker, an RF receiver or transceiver and a battery. The speaker may comprise, for example, a magnetic element attached to a voice-coil-actuated diaphragm, an electrostatically charged diaphragm, a balanced armature driver, or a combination of one or more of these transducer elements. As explained in detail below, the receiver or transceiver of each of the first and second earphones 502, 504 is operable to communicate with one or more external data or audio data devices (e.g., a cellular telephone, PDA, MP3 player, CD player, radio, personal computer, game console, etc.) over one or more wireless links. Each of the first and second earphones 502, 504 may be in the form of an earbud designed to fit into the concha of the pinna of the user's ear; a canalphone, which can be fitted within the ear canal of the user's ear; an over-the-ear circum-aural type headphone; or any other suitable configuration that may be attached to, worn on, or fitted within the user's ear. Each of the first and second earphone 502, 504 may further include a clip, earloop, or other suitable securing mechanism to help maintain the earphone 502 or 504 on the ear of the user. Either or both of the first and second earphones 502, 504 may further be coupled to a second data or audio data source such as, for example, a sensor or a microphone for capturing sound waves generated by the user's 500 voice.

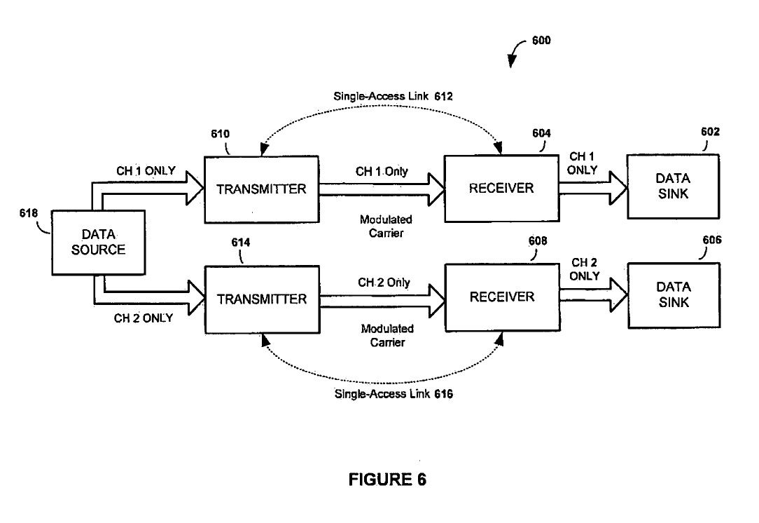

FIG. 6 is a diagram showing a wireless system 600 that may be used to wirelessly transmit data signals to first and second data sinks 602, 606, in accordance with an embodiment of the present invention. According to this and other exemplary embodiments of the invention, the data signals may comprise audio data signals, and the first and second data sinks 602, 606 may correspond to the first and second earphones 502, 504 in FIG. 5. The first data sink 602 is electrically coupled to a first radio frequency (RF) receiver 604 and the second data sink 606 is electrically coupled to a second RF receiver 608. The first and second RF receivers 604, 608 may be analog or digital receivers.

A first RF transmitter 610 is adapted to be wirelessly coupled to the first RF receiver 604 over a first single-access wireless link 612, and a second RF transmitter 614 is adapted to be wirelessly coupled to the second RF receiver 608 over a second single-access wireless link 616. The first and second RF transmitters 610, 614 may be analog or digital transmitters. Further, in an alternative embodiment, one or more of the first and second RF receivers 604, 608 and first and second RF transmitters 610, 614 may comprise one or more RF transceivers, which allow communication in both directions of the first and second single-access wireless links 612, 616.

The first and second RF transmitters 610, 614 are adapted to receive data signals from a data source 618. The data source 618 may comprise a digital data source or an analog data source. For example, the data source 618 may be provided from a digital audio data output of an MP3 player, CD player, PC, PDA, mobile telephone, game console, component of an entertainment system, etc. If the data source 618 is an analog data source, and the RF transmitters 610, 614 are digital transmitters, an analog-to-digital converter (A/D converter) may be provided, either as part of the processing circuitry of the RF transmitter 610 or external to the RF transmitter 610, to convert the analog data signals to digital data signals.

In the wireless system 600 shown in FIG. 6, the data source 618 is electrically coupled to both the first and second transmitters 610, 614, as indicated by the “CH 1” and “CH 2” labels in the drawing. According to an exemplary embodiment, the data provided by the data source 618 comprises first and second digital data streams having data packets formatted in compliance with any one of various wireless technologies. For example, Gaussian Frequency-Shift Keying (GFSK) or Frequency-Shift Keying (FSK) are two exemplary modulation schemes that may be used to. The baseband portions of the first and second RF transmitters 610, 614 may also be configured to operate on the data packets to provide error correction, source encoding and/or channel encoding for error minimization, compression and/or data redundancy purposes.

According to an aspect of the invention, the baseband portion of the first and second RF transmitters 610, 614 in the embodiment of the invention shown in FIG. 4, as well as in other embodiments in this disclosure, process and configure the incoming data from the data source 618 into data packets compliant with the Bluetooth radio standard. Details concerning the Bluetooth radio standard may be found in “Bluetooth End-to-End” by Dee Bakker, Diane McMichael Gilster and Ron Gilster, Hungry Minds, Inc., 2002 (ISBN: 0-7645-4887-5), which is incorporated into this disclosure by reference. Those of ordinary skill in the art will readily appreciate and understand that, whereas the Bluetooth radio standard may be used, that other low power radio standards and communication protocols may alternatively be used.

As shown in FIG. 6, the data signals from the data source 618 are separated into first and second data streams. The first and second data streams are modulated onto RF carriers by the first and second RF transmitters 610, 614 and wirelessly transmitted to the first and second RF receivers 604, 608, via the first and second single-access wireless links 612, 616. Upon receiving the first and second data streams, the first and second RF receivers 604, 608 downconvert the modulated RF carriers and electrically couple the demodulated first and second data streams to the first and second data sinks 602, 606. The baseband portions of the first and second RF receivers 604, 608 may also contain, if necessary, a digital-to-analog (D/A) converter and/or other or additional processing circuitry to facilitate the electrical coupling of the first and second RF receivers 604, 608 to the first and second data sinks 602, 606. Alternatively, such components may be included as part of the data sinks 602, 606 themselves. These additional conversion and signal processing aspects may also be applied to other embodiments of the invention disclosed herein.

If the first and second RF transmitters 610, 614 and first and second RF receivers 604, 608 are implemented as digital transmitters and receivers, the first and second RF transmitters 610, 614 and first and second RF receivers 604, 608 may include data buffers to compensate data packet losses. To compensate for data packet losses, which may be caused by, for example, radio interference, data buffers may be included in each of the first and second RF transmitters 610, 614. Accordingly, if a data packet is lost or for some reason not received by an intended one of the first and second RF receivers 604, 608, the receiver not receiving the data packet may request a resend (ARQ). So long as the communication rate between the requesting receiver and the corresponding transmitter is faster than the data consumption rate of the receivers, the resending of the data packet results in no loss of information to the corresponding data sink 602 or 604.

Timing differences between the first and second data streams may also be of concern, particularly in applications where the data packets comprise audio data. Audio data can be monophonic or stereophonic. In either case, a listener does not perceive delay differences (differential latency) between the left and right speakers (i.e., left and right data sinks 602, 604), so long as the audio data packets in the first and second data streams arrive at the first and second data sinks 602, 606 within about 100 μs of each other. Nevertheless, in some circumstances either or both of the analog-to-digital (A/D) converters of the first and second RF receivers 604, 608 may consume data faster or slower than the data provided by the first and second RF transmitters 610, 614. If either one of the A/D converters is too slow, data sent by the corresponding one of the first and second RF transmitters 610, 614 will be lost at the sending end since the data has no place to go. On the other hand, the A/D converter will stall if it operates too fast, since it will run out of data faster than data is provided to it.

There are a number of ways to compensate for differential latencies between the first and second data streams. One way is to include data buffers in each of the first and second RF receivers 604, 608 and control the buffers so that they maintain a predetermined constant occupancy. So, for example, if the data occupancy of a data buffer of one of the first and second RF receivers 604, 608 becomes too low (e.g., due to a fast A/D converter), interpolated or repeated data samples may be inserted into the data buffer to increase the data occupancy of the buffer, thereby forcing the buffer to maintain the intended predetermined data occupancy. Conversely, if the data occupancy of the data buffer becomes too high (e.g., due to a slow A/D converter) data samples may be removed from the buffer to reduce the data occupancy.

Another way to synchronize the first and second data streams (i.e., reduce the differential latency of the first and second data streams) is to embed the data sample clock used by the first and second RF transmitters 610, 614 in the RF carrier signals used to carry the first and second data streams over the first and second wireless links 612, 616. This may be accomplished by, for example, modulating each of the RF carrier signals associated with the first and second RF transmitters 610, 614 with analog subcarrier signals, which are synchronized with the data source sample clock used at the transmitting end of the system 600. The subcarrier signals can be detected by the respective first and second RF receivers 604, 608 and converted into digital clocks which can drive the A/D converters of the first and second RF receivers 604, 608.

Yet still another way to reduce the differential latency of the first and second data streams is to exclusive OR a pseudo-random noise sequence (PRNS) into the digital modulation of the carrier signals, similar to as is used by the TIA/IS-95 radio standard. If the PRNS used for the first and second data streams is sufficiently long, the PRNS can be correlated at the first and second RF receivers 604, 608, and the delay between the send and receive clocks can be deduced.

Finally, but not necessarily lastly, the differential latency between the first and second data streams may be reduced by monitoring the data buffers or delays, and adjusting the clock signals used by the A/D converters of the first and second RF receivers 604, 608. Accordingly, if the occupancy of a data buffer of one of the first and second RF receivers 604, 608 is too low (or the receive clock/sample clock delay is decreasing), the A/D clock is slowed down. Conversely, if it is determined that the occupancy of the data buffer is too high (or the delay is increasing), the A/D clock is sped up.

The first and second RF transmitters 610, 614 and first and second RF receivers 604, 608 may be implemented in various ways. Below is a description of a few examples of how the transmitters and receivers may be implemented. Those of ordinary skill in the art will appreciate and understand that these transmitter and receiver implementations are provided here for illustrative purposes only and that other types of transmitters and receivers may alternatively be used.

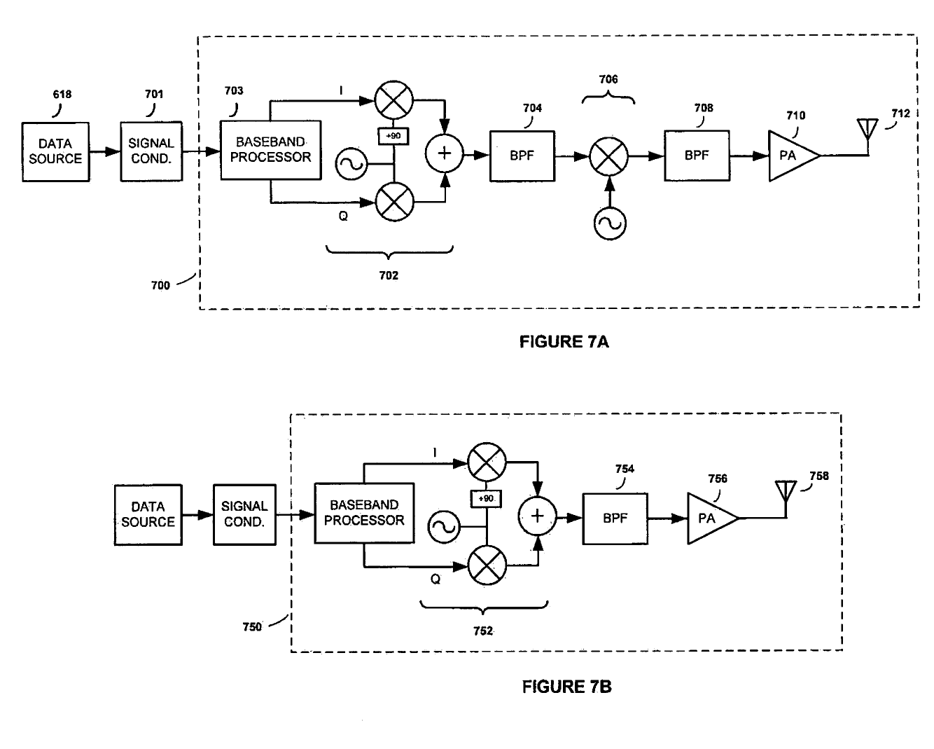

FIG. 7A is a diagram of a two-stage (heterodyne) transmitter 700 that may be used to implement each of the first and second transmitters 610, 614 in the wireless system 600 in FIG. 6. The two-stage transmitter 700 comprises a quadrature modulator 702, a first band-pass filter 704, an RF upconverter 706, a second band-pass filter 708 an RF power amplifier 710, and an antenna 712. The quadrature modulator 702 is operable to receive in-phase (I) and quadrature (Q) channels of the first data stream from the data source 618 and upconvert the data to an intermediate frequency (IF). If necessary, data from the data source 618 may be coupled to a signal conditioning circuit 701 to provide analog-to-digital conversion, filtering, amplification and/or other signal processing functions, before the data is coupled to the baseband portion (i.e., baseband processor 703) of the transmitter 700. The first band-pass filter 704 suppresses harmonics generated by the IF modulation process and provides the filtered output to the RF upconverter 706, which operates to upconvert the filtered IF signal to RF. The second band-pass filter 708 removes unwanted sidebands generated by the RF upconversion process and couples the filtered output to an input of the RF power amplifier 710. The RF power amplifier 710 amplifies the filtered signals and couples the data modulated RF signal to the antenna 712, which radiates the modulated RF signal to the first RF receiver 604 over the first single-access wireless link 612. A second two-stage transmitter operates similarly to upconvert and modulate the I and Q channels of the second data stream from the data source 618 onto an RF carrier signal, which is radiated to the second RF receiver 608 over the second single-access link 616.

FIG. 7B is a diagram of a direct conversion (homodyne) transmitter 750 that may be used to implement each of the first and second transmitters 610, 614 in the wireless system 600 in FIG. 6. The direct conversion transmitter 750 comprises a quadrature modulator 752, a band-pass filter 754, an RF power amplifier 756, and an antenna 758. Rather than using two two-stage transmitters 700 to upconvert the first and second data streams to RF, as is may be done with the two-stage transmitter 700 in FIG. 7A, two direct conversion transmitters 750 may be used. By using a local oscillator frequency that is equal to the RF carrier frequency, the two direct conversion transmitters are operable to directly upconvert the first and second data streams to modulated RF carriers in a single upconversion process.

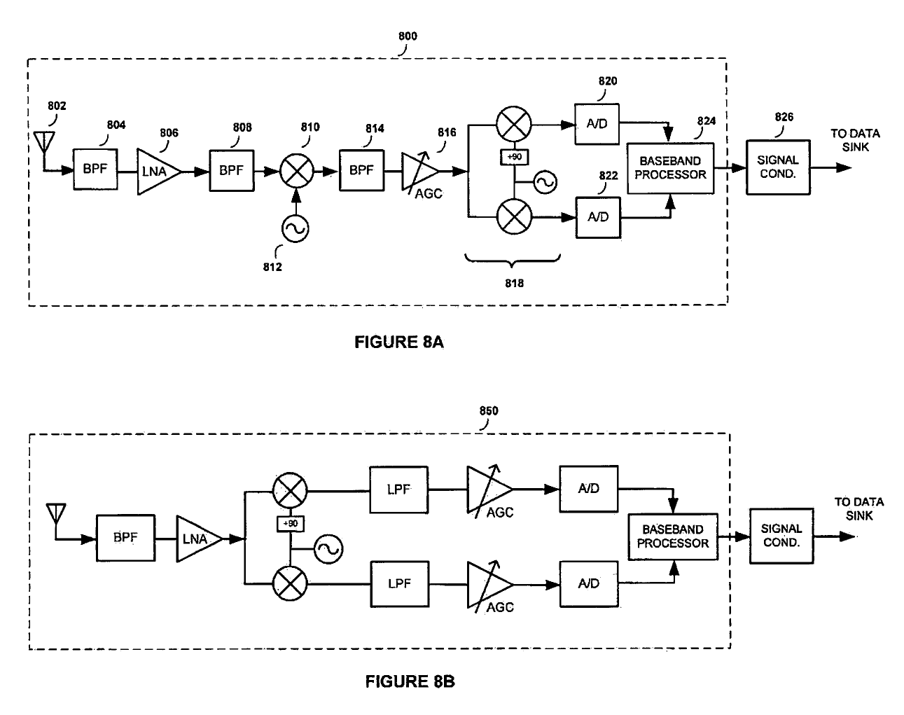

FIG. 8A is a diagram of a superheterodyne receiver 800 that may be used to implement each of the first and second receivers 604, 608 in the wireless system 600 in FIG. 6. The superheterodyne receiver 800 comprises a front-end stage, an RF downconverter, an automatic gain control (AGC) amplifier 816, and a baseband quadrature demodulator 818. The front-end stage comprises an antenna 802, a first band-pass filter 804, a low-noise amplifier (LNA) 806, and a second band-pass filter 808. The RF dowconverter comprises a first mixer 810, a first local oscillator 812, and a third band-bass filter 814.

The first band-pass filter 804 filters the modulated RF signal received by the antenna 802 to preselect the intended frequency band of interest from noise and other unwanted signals, and protects the rest of the receiver 800 from saturation by interfering signals at the antenna 802. The LNA 806 amplifies the filtered signal and couples its output to the second band-pass filter 808, which operates as an image reject filter, protects the RF downconverter from out-of-band interferer signals, and suppresses undesired spurious signals generated by the first mixer 810 of the RF downconverter. Filtered signals from the second band-pass filter 808 are coupled to the mixer 810 of the RF downconverter, which operates to transfer the modulation on the RF signal to IF. Spurious products generated by the mixer 810 are filtered out by the third band-pass filter 814. The filtered IF signal is then coupled to an input of the AGC amplifier 816, which operates to maintain as wide a dynamic range as possible for varying levels of RF received by the receiver 800. The baseband quadrature demodulator 818 extracts the baseband signals from the IF. The extracted baseband signals are digitized by analog-to-digital (A/D) converters 820, 822 and transmitted to a baseband processor 824. Processed data from the baseband processor 824 is then coupled to the first and second data sinks. To ensure that the processed data is in a form suitable to drive the first and second data sinks 602, 606, the processed data from the baseband processor 824 may be first coupled to a signal conditioning circuit 826 to provide digital-to-analog conversion, filtering, amplification, and/or other signal processing functions.

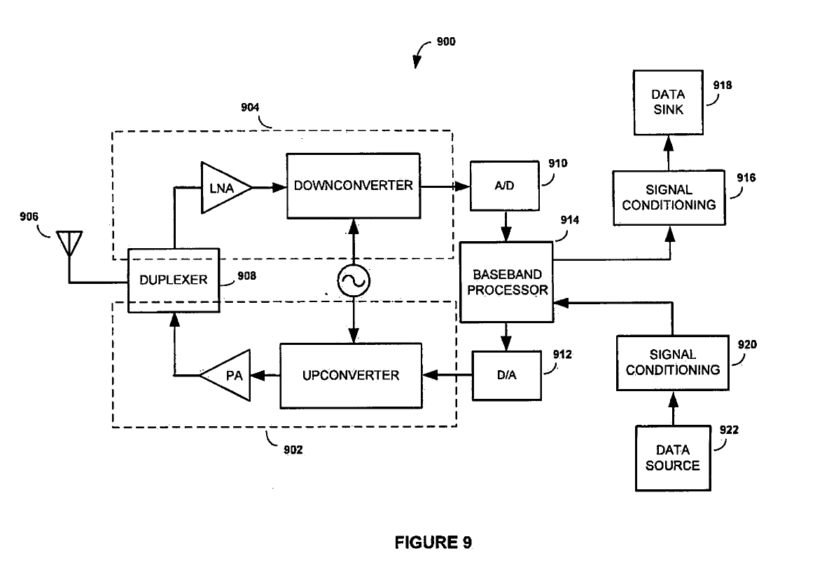

The first and second receivers 604, 608 in the wireless system 600 in FIG. 6 may alternatively be downconverted using a direct conversion (or “zero IF”) receiver. FIG. 8B is a diagram of a direct conversion receiver 850 that may be used to implement these functions. The direct conversion receiver 850 operates similar to the superheterodyne receiver 800 in FIG. 8A except that the conversion is performed in one step. Because the RF signals are downconverted in a single operation, there is no need for an image reject filter (second band-pass filter 808 in FIG. 8A) at the front end of the receiver 850.

Whereas the wireless system 600 above has been described as comprising RF transmitters and RF receivers, in an alternative embodiment RF transceivers containing both an RF transmitter and an RF receiver may be used in place of each of the RF transmitters 610, 614 and RF receivers 604, 608. The same alteration is also applicable to the other embodiments set forth in this disclosure. FIG. 9 is a block diagram of an RF transceiver 900 that may be used for this purpose. The RF transceiver 900 comprises an RF transmitter portion 902, an RF receiver portion 904, an antenna 906, and a duplexer 908. The duplexer 908 operates to isolate the transceiver portion 904 from the transmitter portion 902. An A/D converter 910 receives downconverted analog baseband signals from the RF transceiver portion 904, digitizes the signals, and sends the digitized baseband signals to a baseband processor 914. If necessary, the processed data from the baseband processor 914 may be coupled to a signal conditioning circuit 916 to provide digital-to-analog conversion, filtering, amplification, and/or other signal processing functions, to ensure that the processed data is in a form suitable to drive the data sink 918.

For the RF transmitter portion 902, a D/A converter 912 is adapted to receive data signals from a data source 922 and operable to convert the data signals into analogs signals, which are upconverted to RF by the RF transmitter in preparation of being radiated over the appropriate wireless link by the antenna 906. If necessary, data from the data source 922 may be coupled to a signal conditioning circuit 920 to provide analog-to-digital conversion, filtering, amplification and/or other signal processing functions, before the data is coupled to the baseband processor 914.

While the exemplary RF transceiver 900 in FIG. 9 has been shown and described as comprising an RF transmitter portion 902 and an RF receiver portion 904 that share the same antenna and use a common wireless technology, an alternative RF transceiver design may comprise an RF transmitter portion and receiver portion configured to use separate antennas. The RF transceiver may further include additional circuitry and processing capabilities that allow the RF transmitter and receiver portions to operate in accordance with different wireless technologies.

As discussed above, the wireless system 600 in FIG. 6 uses a separate transmitter/receiver pair or transceiver/transceiver pair (if transceivers are used) for each channel. Because each transmitter/receiver pair is dedicated to a single channel, the data rate in each channel can be lower than the data rate that would be necessary if both of the separated data streams were transmitted over each wireless link 612, 616. The lower data rate over the first and second single-access wireless links 612, 616 allows the use of more economical electrical components, and allows the system components to operate at lower power levels. Furthermore, this embodiment of the present invention allows for independent power control of the transmitter/receiver or transceiver/transceiver pairs, which allows each transmitter/receiver or transceiver/transceiver pair to consume only as much power as is required to communicate.

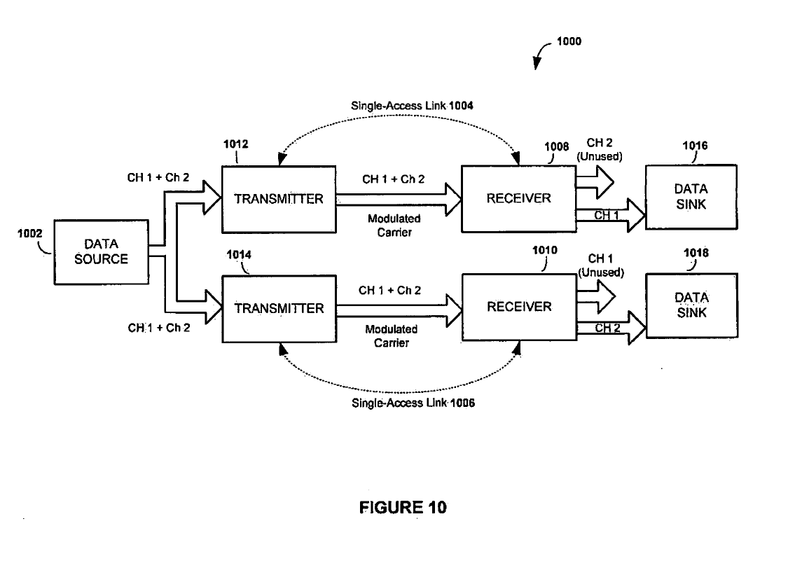

In some applications, however, it may not be possible to reduce the data rate, or it may be desirable for one reason or another to maintain both the first and second data streams on the same wireless link. If such circumstances arise, the wireless system 1000 shown in FIG. 10 may be used. According to this embodiment of the invention, data for both the first and second data sinks 1016, 1018 (e.g., audio data intended for both the right-ear and left-ear earphones 502, 504) are both transmitted on each of single-access wireless links 1004, 1006. The first and second receivers 1008, 1010 are each configured to receive both the first and second data streams from the first and second transmitters 1012, 1014 and couple only the appropriate one of the data streams to the first and second data sinks 1016, 1018 of the system. Compensation for data packet loss and differential latency of the first and second data streams may be accomplished using techniques similar to those described above for the embodiment shown in FIG. 6. Further those techniques, or similar techniques, may be applicable to other embodiments disclosed herein.

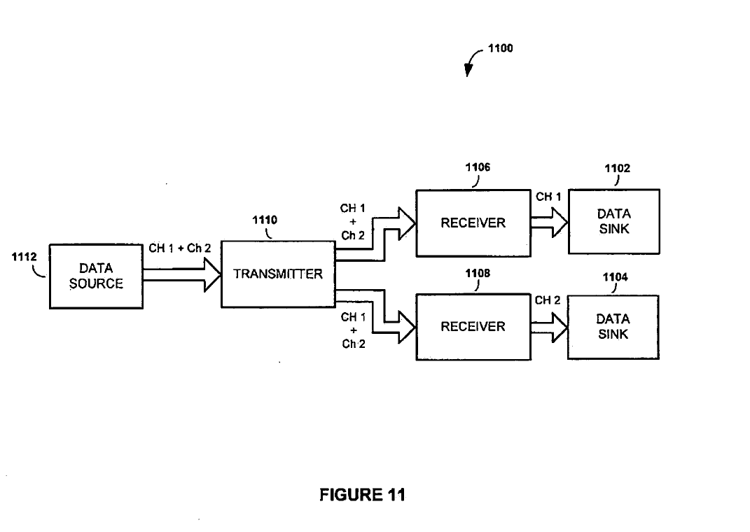

According to an alternative embodiment of the invention shown in FIG. 11, a single source transmitter (or source transceiver) 1102 may be used to broadcast data from the data source 1112 to first and second RF receivers 1106, 1108, instead of the first and second transmitters 1012, 1014 used in the embodiment shown in FIG. 10. Those of ordinary skill in the art will readily appreciate and understand that the wireless system 1100, as well as the other embodiments set forth in this disclosure, may comprise either analog or digital radio techniques. In the case of a digital implementation, differential latency of data received by the first and second RF receivers 1106, 1108 may be reduced or maintained at a predetermined level by including data buffers in the first and second RF receivers 1106, 1108. By controlling and maintaining the data occupancy of the data buffers at some constant predetermine data occupancy level, similar to that described above in connection with the embodiment shown in FIG. 6, the differential latency can be reduced or maintained at predetermined levels.

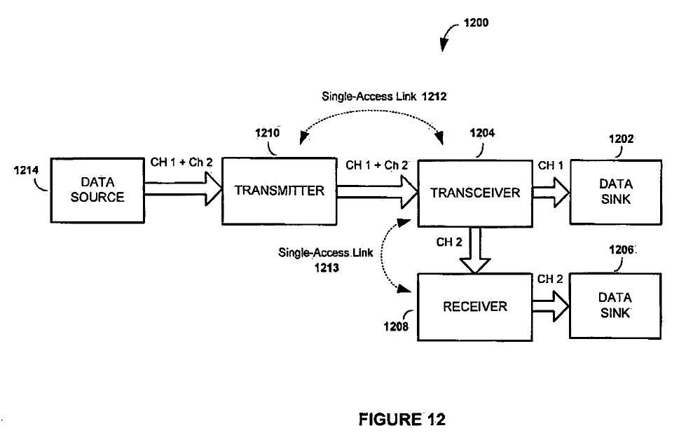

Referring now to FIG. 12, there is shown a wireless system 1200 that may be used to provide data signals (e.g., audio data signals) to first and second data sinks (e.g., first and second earphones 502, 504 in FIG. 5), in accordance with an alternate embodiment of the present invention. The wireless system 1200 includes a single RF transmitter 1210, which is adapted to be wirelessly coupled to an RF transceiver 1204 over a first single-access wireless link 1212. The RF transmitter 1210 operates to wirelessly transmit data streams intended for both the first and second data sinks 1202, 1206 to the RF transceiver 1204. The RF transceiver 1204 receives the data modulated onto the RF carrier, downconverts the data modulated RF carrier, and couples the data needed only for operation of the first data sink 1202 (e.g., right channel stereo indicated as “CH 1” in the drawing) to the first data sink 1202. A transmitter portion of the RF transceiver 1204 transmits data needed only for the operation of the second data sink 1206 to an RF receiver 1208 over a second single-access wireless link 1213. The RF receiver 1208 operates to downconvert the data modulated signal and couple the downconverted data to the second data sink 1206. Communication between the transmitter portion of the RF transceiver 1204 and the receiver 1208 may be conducted in accordance with the same or similar wireless technology as used by the source transmitter 1210 and the receiver portion of the RF transceiver 1204, or may use a different wireless technology. As in other embodiments disclosed herein, the receiver portion of the RF transceiver 1204 and the receiver 1208 may include data buffers that are controlled to compensate for, or reduce the differential latency of, data arriving at the first and second data sinks 1202, 1206. In particular, the data buffer occupancies of the RF transceiver 1204 and/or the receiver 1208 can be controlled to compensate for the delay imparted to the data routed through the RF receiver 1208, so that the differential latency between data arriving at the first data sink 1202 and data arriving at the second data sinks 1206 is reduced or controlled to within some predetermined threshold.

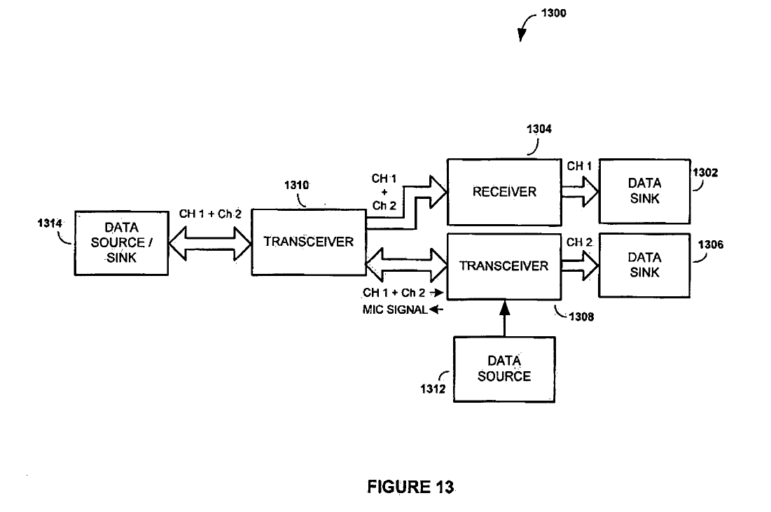

According to an embodiment of the invention, either or both the first and second data sinks of the various embodiments may include (or be coupled to) a data source such as, for example, a sensor or a microphone to allow a data to be sent back to an external electronic device. FIG. 13 shows a wireless system 1300 that may be used to provide data signals (e.g., audio data signals) to first and second data sinks (e.g., the first and second earphones 502, 504 in FIG. 5, and also provide data signals back to the external electronic device, in accordance with an alternate embodiment of the present invention. The wireless system 1300 comprises first and second data sinks 1302, 1306, which are electrically coupled to an RF receiver 1304 (or transceiver) and a first RF transceiver 1308, respectively. A second RF transceiver 1310 is adapted to be wirelessly coupled to the RF receiver 1304 and the first RF transceiver 1308. The second RF transceiver 1310 is adapted to receive data from a data source 1314 and broadcast an RF carrier, which is modulated by the data, to both the receiver 1304 and the first RF transceiver 1308. The second RF transceiver 1310 is also adapted to receive data modulated carrier signals (e.g., voice data modulated carrier signals) in the reverse direction from the first RF transceiver 1308, which receives data signals from a data source 1312 comprising, for example, a sensor or a microphone. The data modulated signals are downconverted by the second RF transceiver 1310 and coupled to a data source/data sink 1314. The data signal extracted may then be provided as data signals to an external electronic device, e.g., an external audio device. Those of ordinary skill in the art will readily appreciate and understand that a similar data source may also be incorporated in any on of the other embodiments described in this disclosure.

Those of ordinary skill in the art will readily appreciate and understand that the wireless system 1300, as well as the other embodiments set forth in this disclosure, may comprise either analog or digital radio techniques. In the case of a digital implementation, differential latency of data received by the RF receiver 1304 and the receiver portion of the first RF transceiver 1308 may be reduced or maintained at a predetermined level by including data buffers in the RF receiver 1304 and the receiver portion of the first RF transceiver 1308. By controlling and maintaining the data occupancy of the data buffers at some constant predetermine data occupancy level, similar to that described above in connection with the embodiment shown in FIG. 6, the differential latency can be reduced or maintained at predetermined levels.

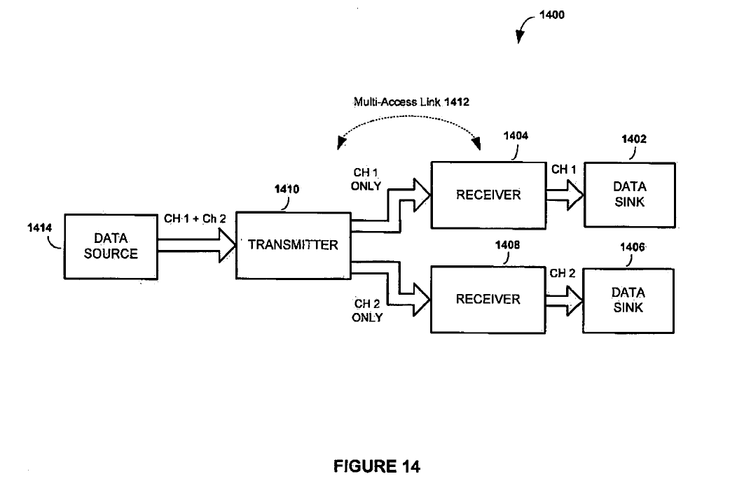

FIG. 14 is a diagram of a wireless system 1400, in accordance with another embodiment of the present invention. Similar to the previously described embodiments, the wireless system 1400 may be used to provide data signals (e.g., audio data signals) to first and second data sinks (e.g., to the first and second earphones 502, 504 in FIG. 5). The wireless system 1400 includes a single multi-access RF transmitter (or transceiver) 1410, which is adapted to be wirelessly coupled to first and second multi-access RF receivers (or transceivers) 1404, 1408 over a multi-access wireless link 1412. Data packets from a data source are separated (or “multiplexed”) by use of distinct codes or time slots that are uniquely assigned to the first and second RF receivers 1404 and 1408. The multi-access RF transmitter 1410 transmits the data packets according to the time slots or codes over the multi-access wireless link 1412. The RF receivers 1404, 1408 operate to extract and downconvert their intended data packets based on the time slots or codes uniquely allocated to them. Those of ordinary skill in the art will readily appreciate that, similar to the embodiments described above, the first and second RF receivers 1404, 1408 may include data buffers that are controlled so that the data provided to the first and second data sinks 1402, 1404 have a differential latency that is at or below a predetermined threshold.

Any one of a number of multi-access data protocols may be employed by the wireless system 1400. As an example, time domain multiple access (TDMA) multiplexing may be used. TDMA multiplexes the data packets of the first and second data streams in time so that the RF transmitter 1410 may transmit the time multiplexed data packets in time slots. The first and second receivers 1404, 1408 are synchronized with the RF transmitter 1410 so that appropriate data packets modulated on the RF carrier over the multi-access link 1412 can be extracted by the first and second RF receivers 1404, 1408 during their allocated time slots.

Code domain multiple access (CDMA) is another multi-access data protocol that may be used in the multi-access wireless system 1400 in FIG. 14. Rather than using time to multiplex the data packets of the first and second data streams, CDMA operates to encode, and thereby multiplex, the data packets with orthogonal codes that are uniquely assigned and known by the first and second RF receivers 1404, 1408. The first and second RF receivers 1404, 1408 are then only capable of extracting data packets having the unique codes assigned to them. Details of the CDMA and TDMA multi-access protocols may be found in “Principles of Wireless Networks: A Unified Approach” by P. Krishnamurthy and K. Pahlavan, Prentice Hall, 2002 (ISBN: 0-130-93003-2), and “RF System Design of Transceivers for Wireless Communications” by Q. Gu, Springer Science—Business Media, Inc., 2005 (ISBN: 0-387-24161-2), both which are incorporated into this disclosure by reference.

Although the present invention has been described with reference to specific embodiments thereof, these embodiments are merely illustrative, and not restrictive, of the present invention. Various modifications or changes to the specifically disclosed exemplary embodiments will be suggested to persons skilled in the art. For example, while some of the various disclosed embodiments have been described in the context of wireless systems for wireless earphones, the apparatus, systems and methods disclosed herein are applicable to any application in which a plurality of unconnected wireless data sinks is desirable. For example, the various disclosed embodiments may be used to form a home entertainment system in which the plurality of data sinks correspond to a plurality of physically unconnected wireless speakers.

Furthermore, while the various exemplary embodiments herein are described as containing first and second data sinks, those of ordinary skill in the art will readily appreciate and understand that the general concept of wireless transmission to physically unconnected wireless data sinks may be applied to wireless systems with more than two data sinks (e.g., for a fully wireless surround sound type system).

Still further, whereas the various disclosed embodiments have been described as transmitting and receiving RF signals, the transmitters, receivers and transceivers may alternatively be configured to transmit and receive according to other types of wireless techniques, e.g., optical, ultrasound, non-radiated wireless techniques such as over-the-body inductive or capacitive coupling, etc.

Accordingly, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A wireless system, comprising:
a first wireless receiver coupled to a first data sink; and
a second wireless receiver coupled to a second data sink,
wherein said first and second data sinks have no physical or electrical connection between them, and said first and second wireless receivers are operable to reduce a differential latency between data received by said first wireless receiver and data received by said second wireless receiver.

2. The wireless system of claim 1 wherein said first and second data sinks comprise first and second earphones adapted to fit into first and second ears of a user.

3. The wireless system of claim 1 wherein said first and second data sinks comprise first and second circum-aural headphones adapted to fit over first and second ears of a user.

4. The wireless system of claim 1 wherein said first and second data sinks comprise first and second speakers.

5. The wireless system of claim 1 wherein said first wireless receiver is configured to receive a data modulated carrier signal from a single wireless transmitter.

6. The wireless system of claim 5 wherein said second wireless receiver is also configured to receive the data modulated carrier signal from said single wireless transmitter.

7. The wireless system of claim 1 wherein:
said first wireless receiver is configured to receive a first data modulated carrier signal from a first wireless transmitter over a first single-access wireless link; and
said second wireless receiver is configured to receive a second data modulated signal from a second wireless transmitter over a second single-access wireless link.

8. The wireless system of claim 7 wherein the data modulated onto the first data modulated carrier signal is the same as the data modulated onto the second data modulated carrier signal.

9. The wireless system of claim 7 wherein the data modulated onto the first data modulated carrier signal is different from the data modulated onto the second data modulated carrier signal.

10. The wireless system of claim 1, further comprising a wireless transmitter operable to transmit at least a subset of data received by said first one of said first and second wireless receivers to a second one of said first and second wireless receivers.

11. The wireless system of claim 10 wherein said first one of said first and second wireless receivers is adapted to receive data signals according to a first wireless technology and said second one of said first and second wireless receivers is adapted to receive data signals according to a second wireless technology.

12. The wireless system of claim 1 further comprising:
a wireless transmitter coupled to one of said first and second wireless receivers; and
a data source coupled to said wireless transmitter.

13. The wireless system of claim 12 wherein said data source comprises a sensor.

14. The wireless system of claim 12 wherein said data source comprises a microphone.

15. The wireless system of claim 1 wherein at least one of said first and second wireless receivers is configured to receive data signals in accordance with the Bluetooth radio standard.

16. The wireless system of claim 1 wherein:
said first wireless receiver is configured to receive a first data modulated carrier signal carrying data exclusively for said first data sink; and
said second wireless receiver is configured to receive a second data modulated carrier signal carrying data exclusively for said second data sink.

17. The wireless system of claim 1 wherein said first and second wireless receivers are configured to receive data modulated carrier signals from a multi-access wireless transmitter over a multi-access wireless link.

18. A wireless headphone system, comprising:
a right-ear data sink having first means for wirelessly receiving a data modulated carrier signal; and
a left-ear data sink having second means for wirelessly receiving a data modulated carrier signal,
wherein said right-ear and left-ear data sinks have no physical or electrical connection between them.

19. The wireless headphone system of claim 18, further comprising means for reducing differential latency between data received by said first means and data received by said second means.

20. The wireless headphone system of claim 18 wherein the data modulated carrier signal received by the first means includes the same data as the data modulated carrier signal received by the second means.

21. The wireless headphone system of claim 18 wherein the data modulated carrier signal received by the first means includes data that is different from the data included in the data modulated carrier signal received by the second means.

22. The wireless headphone system of claim 18 wherein the data modulated carrier signal received by the first means and the data modulated carrier signal received by the second means are both transmitted from a single wireless transmitter.

23. The wireless headphone system of claim 18 wherein the data modulated carrier signal received by the first means is transmitted from a first wireless transmitter and the data modulated carrier signal received by the second means is transmitted from a second wireless transmitter.

24. The wireless headphone system of claim 18 wherein the first means and the second means are adapted to receive data modulated carrier signals from a multi-access wireless transmitter over a multi-access wireless link.

25. The wireless headphone system of claim 18, further comprising a wireless transmitter coupled to one of said right-ear and left ear data sinks, said wireless transmitter configured to receive data from a data source.

26. The wireless headphone system of claim 25 wherein said data source comprises a sensor.

27. The wireless headphone system of claim 25 wherein said data source comprises a microphone.

28. The wireless headphone system of claim 18 wherein at least one of said first and second means is adapted to receive a data modulated carrier signal that is compliant with the Bluetooth radio standard.

29. A wireless communication system, comprising:
a first data sink coupled to a first wireless communication means;
a second data sink coupled to a second wireless communication means; and
third wireless communication means for modulating data from a first data source onto one or more carrier signals and transmitting one or more data modulated carrier signals to at least one of said first and second wireless communication means,
wherein said first and second data sinks have no physical or electrical connection between them and at least one of said first and second wireless communication means is operable to reduce a differential latency between data provided to said first data sink and data provided to said second data sink.

30. The wireless communication system of claim 29 wherein said first wireless communication means includes wireless transmission means for wirelessly transmitting at least a subset of data received by said first wireless communication means to said second wireless communication means.

31. The wireless communication system of claim 30 wherein said at least a subset of said data transmitted by said wireless transmission means to said second wireless communication means is transmitted according to a first wireless technology and data transmitted by said third wireless communication means to said at least one of said first and second wireless transmission means is transmitted according to a second wireless technology.

32. The wireless communication system of claim 29, further comprising:
a second data source adapted to provide data to transmission means of said first wireless communication means; and
means for receiving from said transmission means a wireless carrier signal modulated by data from said second data source.

33. The wireless communication system of claim 32 wherein said second data source comprises a sensor.

34. The wireless communication system of claim 32 wherein said second data source comprises a microphone.

35. The wireless communication system of claim 29 wherein said third communication means includes a single wireless transmitter operable to modulate data from said first data source onto a single carrier signal, and broadcast the data modulated carrier signal to said first and second wireless communication means.

36. The wireless communication system of claim 29 wherein said third communication means comprises:
a first wireless transmitter operable to transmit a first carrier signal modulated by a first subset of data provided by said first data source to said first wireless communication means; and
a second wireless transmitter operable to transmit a second carrier signal modulated by a second subset of data provided by said first data source to said second wireless communication means.

37. The wireless communication system of claim 29 wherein said third wireless communication means comprises first and second wireless transmitters that are both operable to modulate data for reception by both said first and second communication means onto a single carrier signal.

38. The wireless communication system of claim 29 wherein said third wireless communication means comprises first and second wireless transmitters operable to modulate data for reception by said first and second communication means, respectively, onto first and second carrier signals.

39. The wireless communication system of claim 29 wherein:
said first data sink comprises a first earphone adapted to fit into a first ear of a user; and
said second data sink comprises a second earphone adapted to fit into a second ear of the user.

40. The wireless communication system of claim 29 wherein:
said first data sink comprises a first circum-aural headphone adapted to fit over a first ear of a user; and
said second data sink comprises a second circum-aural headphone adapted to fit over a second ear of the user.

41. The wireless communication system of claim 29 wherein said first, second and third wireless communication means comprises multi-access wireless communication means that communicate over a multi-access wireless link.

42. The wireless communication system of claim 29 wherein at least one of said first and second wireless communication means is adapted to receive a data modulated carrier signal in accordance with the Bluetooth radio standard.
